(19) United States
(12) Patent Application Publication
(10) Pub. No.: US 2025/0187403 A1
(43) Pub. Date: Jun. 12, 2025

(54) VEHICLE HVAC SYSTEM AND A METHOD OF CONTROLLING THE SAME

(71) Applicants: HYUNDAI MOTOR COMPANY, Seoul (KR); KIA CORPORATION, Seoul (KR)

(72) Inventors: Tae Woong Lim, Hwaseong-si (KR); Ji Wan Son, Yongin-si (KR); Kyu Ho Chae, Seoul (KR); Chan Woong Jo, Yongin-si (KR); Jae Won Heo, Seoul (KR); Chang Hwan Kim, Seoul (KR)

(73) Assignees: HYUNDAI MOTOR COMPANY, Seoul (KR); KIA CORPORATION, Seoul (KR)

(21) Appl. No.: 18/784,130

(22) Filed: Jul. 25, 2024

(30) Foreign Application Priority Data
Dec. 6, 2023 (KR) 10-2023-0176004

(51) Int. Cl. B60H 1/32; B60H 1/00

(52) U.S. Cl. CPC B60H 1/3208; B60H 1/00392

(57) ABSTRACT

A vehicle heating, ventilation, and air conditioning (HVAC) system is provided. The system includes a compressor having: a compression section; a motor section configured to drive the compression section; and an inverter configured to allow the motor section to operate in any one of an efficiency mode and a lossy mode. The system also includes a controller configured to control the inverter of the compressor based on a minimum temperature of a refrigerant and a freezing temperature of refrigerant oil contained in the refrigerant.

### CROSS-REFERENCE TO RELATED APPLICATION

This application claims the benefit of and priority to Korean Patent Application No. 10-2023-0176004, filed on Dec. 6, 2023, in the Korean Intellectual Property Office, the disclosure of which is incorporated herein in its entirety by reference.

### TECHNICAL FIELD

The present disclosure relates to a vehicle heating, ventilation, and air conditioning (HVAC) system and a method of controlling the same. More particularly, the present disclosure relates to a vehicle HVAC system and a method of controlling the same to operate a compressor in a heat generating mode.

### BACKGROUND

With growing interest in energy efficiency and environmental issues, there is a demand for the development of eco-friendly vehicles that can replace internal combustion engine vehicles. Such eco-friendly vehicles are classified into electric vehicles which are driven using fuel cells or electricity as a power source and hybrid vehicles which are driven using an engine and a battery.

Such eco-friendly vehicles may include a vehicle thermal management system for thermal management of a cabin (or passenger compartment), a battery, and the like. The vehicle thermal management system may include a heating, ventilation, and air conditioning (HVAC) system for heating or cooling air discharged to the cabin, and a battery cooling system for cooling the battery. The HVAC system may be thermally connected to the battery cooling system through a battery chiller. The battery chiller may include a refrigerant passage through which a refrigerant circulating in the HVAC system passes, and a battery coolant passage through which a battery coolant circulating in the battery cooling system passes. The battery chiller may be designed to cool the battery coolant using the refrigerant.

The HVAC system may include a refrigerant circulation path through which the refrigerant circulates. The refrigerant circulation path may be fluidly connected to a compressor, an evaporator, an interior condenser, a heating-side expansion valve, an exterior heat exchanger, a cooling-side expansion valve, and the like.

When the HVAC system operates in a heating mode in a condition in which the outdoor temperature of the vehicle is low, cabin heating performance achieved by the refrigerant circulating in the HVAC system may be relatively reduced. Additionally, an amount of consumption of electric energy may increase with the use of an electric vehicle.

In addition, when the HVAC system operates in the heating mode in a low temperature condition, and a minimum temperature of the refrigerant is relatively lowered below a freezing temperature of refrigerant oil contained in the refrigerant, the refrigerant oil contained in the refrigerant may freeze, and a density of the refrigerant may be reduced to thereby restrict RPM of the compressor. Accordingly, when the HVAC system operates in the heating mode, the amount of heat transferred from the refrigerant to the cabin may be limited.

The above information described in the Background section is provided to assist in understanding the background of the present disclosure. The Background section may include any technical concept which is not considered as the prior art In other words already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle thermal management including system a vehicle heating, ventilation, and air conditioning (HVAC) system and a method of controlling the same to control an inverter of a compressor based on a temperature of a refrigerant, a freezing temperature of refrigerant oil, and a component temperature of the compressor, thereby preventing the freezing of the refrigerant oil and improving cabin heating performance.

According to an aspect of the present disclosure, a vehicle HVAC system may include a compressor including a compression section, a motor section configured to drive the compression section, and an inverter configured to allow the motor section to operate in any one of an efficiency mode and a lossy mode. The system may also include a controller configured to control the inverter of the compressor based on a minimum temperature of a refrigerant and a freezing temperature of refrigerant oil contained in the refrigerant.

The controller may be configured to control the inverter of the compressor to operate in a heat generating mode when a temperature difference between the minimum temperature of the refrigerant and the freezing temperature of the refrigerant oil contained in the refrigerant is lower than a threshold value and a component temperature of the compressor is lower than an acceptable temperature. The heat generating mode may refer to a mode in which additional heat is generated from the compressor as the inverter allows the motor section to operate in the lossy mode.

The controller may be configured to calculate a vehicle desired heat amount and a maximum heat capacity when a temperature difference between the minimum temperature of the refrigerant and the freezing temperature of the refrigerant oil contained in the refrigerant is lower than a threshold value. The maximum heat capacity may refer to a maximum amount of heat transferred from the refrigerant to a cabin when the HVAC system operates in a heating mode.

In one embodiment, when the maximum heat capacity is lower than the vehicle desired heat amount, the controller may be configured to select a control mode and a control parameter of the motor section of the compressor based on a difference between the vehicle desired heat amount and the maximum heat capacity. The controller may be configured to calculate an amount of heat generated from the compressor based on the selected control mode and control parameter, and estimate a component temperature of the compressor based on the calculated amount of heat.

The controller may be configured to control the inverter of the compressor to operate in a heat generating mode when the estimated component temperature is lower than an acceptable temperature.

The controller may be configured to estimate a vibration and noise level generated by the compressor and the refrigerant based on the selected control mode and control parameter when the estimated component temperature is lower than an acceptable temperature.

The controller may be configured to control the inverter of the compressor to operate in a heat generating mode when the vibration and noise level generated by the compressor and the refrigerant is less than an acceptable vibration and noise level.

According to another aspect of the present disclosure, a method of controlling a vehicle heating, ventilation, and air conditioning (HVAC) system is provided. The system may include: a compressor having a compression section, a motor section configured to drive the compression section, and an inverter configured to allow the motor section to operate in any one of an efficiency mode and a lossy mode. The method may include: operating the HVAC system in a heating mode; and controlling, by a controller, the inverter of the compressor based on a minimum temperature of a refrigerant and a freezing temperature of refrigerant oil contained in the refrigerant.

The controlling of the inverter may include controlling, by the controller, the inverter of the compressor to operate in a heat generating mode when a temperature difference between the minimum temperature of the refrigerant and the freezing temperature of the refrigerant oil contained in the refrigerant is lower than a threshold value and a component temperature of the compressor is lower than an acceptable temperature. The heat generating mode may refer to a mode in which additional heat is generated from the compressor as the inverter allows the motor section to operate in the lossy mode.

The controlling of the inverter may include calculating, by the controller, a vehicle desired heat amount and a maximum heat capacity when a temperature difference between the minimum temperature of the refrigerant and the freezing temperature of the refrigerant oil contained in the refrigerant is lower than a threshold value. The maximum heat capacity may refer to a maximum amount of heat transferred from the refrigerant to a cabin when the HVAC system operates in the heating mode.

When the maximum heat capacity is lower than the vehicle desired heat amount, the controlling of the inverter may include selecting, by the controller, a control mode and a control parameter of the motor section of the compressor based on a difference between the vehicle desired heat amount and the maximum heat capacity. The controlling of the inverter may also include: calculating, by the controller, an amount of heat generated from the compressor based on the selected control mode and control parameter; and estimating, by the controller, a component temperature of the compressor based on the calculated amount of heat.

The controlling of the inverter may include controlling, by the controller, the inverter of the compressor to operate in a heat generating mode when the estimated component temperature is lower than an acceptable temperature.

The controlling of the inverter may include estimating, by the controller, a vibration and noise level generated by the compressor and the refrigerant based on the selected control mode and control parameter when the estimated component temperature is lower than an acceptable temperature.

The controlling of the inverter may include controlling, by the controller, the inverter of the compressor to operate in a heat generating mode when the vibration and noise level generated by the compressor and the refrigerant is less than an acceptable vibration and noise level.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a vehicle heating, ventilation, and air conditioning (HVAC) system according to an embodiment of the present disclosure; and

FIG. 2 illustrates a flowchart of a method of controlling a vehicle HVAC system according to an embodiment of the present disclosure.

### DETAILED DESCRIPTION

Hereinafter, the embodiments of the present disclosure are described in detail with reference to the accompanying drawings. In the drawings, the same reference numerals are used throughout to designate the same or equivalent elements. In addition, a detailed description of well-known techniques associated with the present disclosure are ruled out in order not to unnecessarily obscure the gist of the present disclosure.

Terms such as first, second, A, B, (a), and (b) may be used to describe the elements in the embodiments of the present disclosure. These terms are only used to distinguish one element from another element, and the intrinsic features, sequence, or order, and the like of the corresponding elements are not limited by the terms. Unless otherwise defined, all terms used herein, including technical or scientific terms, have the same meanings as those terms generally understood by those having ordinary skill in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

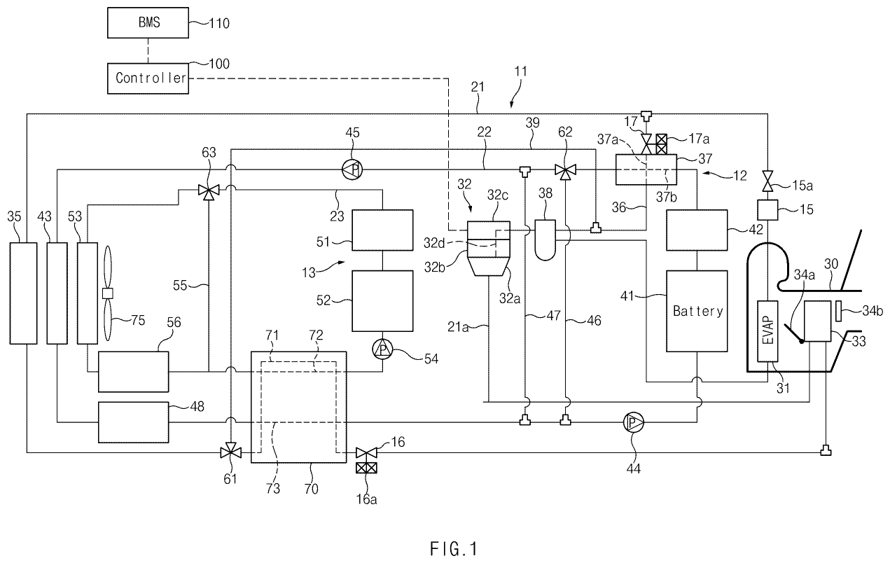

Referring to FIG. 1, a vehicle heating, ventilation, and air conditioning (HVAC) system 11 according to an embodiment of the present disclosure may be configured to heat or cool air in a cabin of the vehicle using a refrigerant circulating in a refrigerant circulation path 21. The refrigerant circulation path 21 may be fluidly connected to an evaporator 31, a compressor 32, an interior condenser 33, a heating-side expansion valve 16, a water-cooled heat exchanger 70, an exterior heat exchanger 35, and a cooling-side expansion valve 15. In FIG. 1, the refrigerant may sequentially pass through the compressor 32, the interior condenser 33, the heating-side expansion valve 16, the water-cooled heat exchanger 70, the exterior heat exchanger 35, the cooling-side expansion valve 15, and the evaporator 31 in the refrigerant circulation path 21.

The evaporator 31 may be configured to evaporate the refrigerant received from the cooling-side expansion valve 15. In other words, the refrigerant expanded by the cooling-side expansion valve 15 may absorb heat from the air and be evaporated in the evaporator 31. During a cooling operation of the HVAC system 11, the evaporator 31 may be configured to cool the air using the refrigerant cooled by the exterior heat exchanger 35 and expanded by the cooling-side expansion valve 15 and the air cooled by the refrigerant may be directed into the cabin.

The compressor 32 may be configured to compress the refrigerant received from the evaporator 31 and/or a battery chiller 37. According to an embodiment, the compressor 32 may be an inverter compressor including an inverter 32c.

The compressor 32 may compress the refrigerant to allow the refrigerant to circulate through the refrigerant circulation path 21.

According to an embodiment of the present disclosure, the compressor 32 may include a compression section 32a compressing the refrigerant, a motor section 32b driving the compression section 32a, and the inverter 32c controlling the motor section 32b. The compressor 32 may have a refrigerant passage 32d provided in the inverter 32c and the motor section 32b, and the refrigerant may flow into the compression section 32a through the refrigerant passage 32d.

The interior condenser 33 may be configured to condense the refrigerant received from the compressor 32. Accordingly, the air passing over the interior condenser 33 may be heated by the refrigerant passing through an internal passage of the interior condenser 33. As the air heated by the interior condenser 33 is directed into the cabin, the heating of the cabin may be performed.

The exterior heat exchanger 35 may be disposed adjacent to a front grille of the vehicle, and the exterior heat exchanger 35 may be exposed to the outside so that heat may be transferred between the exterior heat exchanger 35 and the ambient air. During the cooling operation of the HVAC system 11, the exterior heat exchanger 35 may be configured to condense the refrigerant received from the interior condenser 33. In other words, the exterior heat exchanger 35 may serve as an exterior condenser that condenses the refrigerant by transferring heat to the ambient air during the cooling operation of the HVAC system 11. During a heating operation of the HVAC system 11, the exterior heat exchanger 35 may be configured to evaporate the refrigerant received from the water-cooled heat exchanger 70. In other words, the exterior heat exchanger 35 may serve as an exterior evaporator that evaporates the refrigerant by absorbing heat from the ambient air. In particular, the exterior heat exchanger 35 may exchange heat with the ambient air forcibly blown by a cooling fan 75 so that a heat transfer rate between the exterior heat exchanger 35 and the ambient air may be further increased.

The water-cooled heat exchanger 70 may be configured to transfer heat between the refrigerant circulation path 21 of the HVAC system 11, a battery coolant circulation path 22 of a battery cooling system 12, and a power electronics (PE) coolant circulation path 23 of a PE cooling system 13. Specifically, the water-cooled heat exchanger 70 may be disposed between the interior condenser 33 and the exterior heat exchanger 35 on the refrigerant circulation path 21. The water-cooled heat exchanger 70 may include a refrigerant passage 71 fluidly connected to the refrigerant circulation path 21, a first coolant passage 72 fluidly connected to the PE coolant circulation path 23, and a second coolant passage 73 fluidly connected to the battery coolant circulation path 22.

During the heating operation of the HVAC system 11, the water-cooled heat exchanger 70 may be configured to evaporate the refrigerant received from the interior condenser 33 using heat transferred from the PE cooling system 13. In other words, during the heating operation of the HVAC system 11, the water-cooled heat exchanger 70 may serve as an evaporator that evaporates the refrigerant by recovering waste heat from an electric motor 51 and a PE component 52 of the PE cooling system 13.

During the cooling operation of the HVAC system 11, the water-cooled heat exchanger 70 may be configured to condense the refrigerant received from the interior condenser 33. The water-cooled heat exchanger 70 may serve as a condenser that condenses the refrigerant by cooling the refrigerant using a battery coolant circulating in the battery coolant circulation path 22 of the battery cooling system 12 and a PE coolant circulating in the PE coolant circulation path 23 of the PE cooling system 13.

The heating-side expansion valve 16 may be disposed on the upstream side of the water-cooled heat exchanger 70 in the refrigerant circulation path 21. Specifically, the heating-side expansion valve 16 may be disposed between the interior condenser 33 and the water-cooled heat exchanger 70. The heating-side expansion valve 16 may adjust the flow of the refrigerant and/or the flow rate of the refrigerant into the water-cooled heat exchanger 70 during the heating operation of the HVAC system 11. The heating-side expansion valve 16 may be configured to expand the refrigerant received from the interior condenser 33 during the heating operation of the HVAC system 11.

According to an embodiment, the heating-side expansion valve 16 may be an electronic expansion valve (EXV) having a drive motor 16a. The drive motor 16a may have a shaft which is movable to open or close an orifice defined in a valve body of the heating-side expansion valve 16, and the position of the shaft may be varied depending on the rotation direction, rotation degree, and the like of the drive motor 16a. Accordingly, the opening degree of the orifice of the heating-side expansion valve 16 may be varied. A controller 100 may control the operation of the drive motor 16a. The heating-side expansion valve 16 may be a full open type EXV.

The opening degree of the heating-side expansion valve 16 may be varied under control of the controller 100. As the opening degree of the heating-side expansion valve 16 is varied, the flow rate of the refrigerant into the refrigerant passage 71 of the water-cooled heat exchanger 70 may be varied. The heating-side expansion valve 16 may be controlled by the controller 100 during the heating operation of the HVAC system 11.

The cooling-side expansion valve 15 may be disposed between the exterior heat exchanger 35 and the evaporator 31 in the refrigerant circulation path 21. The cooling-side expansion valve 15 may be disposed on the upstream side of the evaporator 31 so that it may adjust the flow of the refrigerant and/or the flow rate of the refrigerant into the evaporator 31. Additionally, the cooling-side expansion valve 15 may be configured to expand the refrigerant received from the exterior heat exchanger 35.

According to an embodiment, the cooling-side expansion valve 15 may be a thermal expansion valve (TXV) that senses the temperature and/or pressure of the refrigerant and adjusts the opening degree of the cooling-side expansion valve 15. Specifically, the cooling-side expansion valve 15 may be a TXV having a shut-off valve 15a selectively blocking or unblocking the flow of the refrigerant into an internal passage of the cooling-side expansion valve 15. The shut-off valve 15a may be a solenoid valve. The shut-off valve 15a may be opened or closed by the controller 100 so that the shut-off valve 15a may unblock or block the flow of the refrigerant into the cooling-side expansion valve 15. When the shut-off valve 15a is opened, the refrigerant may be allowed to flow into the cooling-side expansion valve 15, and when the shut-off valve 15a is closed, the refrigerant may be blocked from flowing into the cooling-side expansion valve 15. According to an embodiment, the shut-off valve 15a may be mounted in a valve body of the cooling-side expansion valve 15, thereby opening or closing the internal passage of the cooling-side expansion valve 15. According to another embodiment, the shut-off valve 15a may be disposed on the upstream side of the cooling-side expansion valve 15, thereby selectively opening or closing an inlet of the cooling-side expansion valve 15.

When the shut-off valve 15a is closed, the cooling-side expansion valve 15 may be blocked, and accordingly the refrigerant may not be directed to the cooling-side expansion valve 15 and the evaporator 31, but may only be directed to the battery chiller 37. In other words, when the shut-off valve 15a of the cooling-side expansion valve 15 is closed, the cooling operation of the HVAC system 11 may not be performed, and only the battery chiller 37 may be cooled or the heating operation of the HVAC system 11 may be performed. When the shut-off valve 15a is opened, the refrigerant may be directed to the cooling-side expansion valve and the evaporator 31. In other words, when the shut-off valve 15a of the cooling-side expansion valve 15 is opened, the cooling operation of the HVAC system 11 may be performed.

The HVAC system 11 may include an HVAC case 30 having an inlet and an outlet. The HVAC case 30 may be configured to allow the air to flow into the cabin of the vehicle. The evaporator 31 and the interior condenser 33 may be located in the HVAC case 30. An air mixing door 34a may be disposed between the evaporator 31 and the interior condenser 33, and a positive temperature coefficient (PTC) heater 34b may be disposed on the downstream side of the interior condenser 33.

The HVAC system 11 may further include an accumulator 38 disposed between the evaporator 31 and the compressor 32 in the refrigerant circulation path 21, and the accumulator 38 may be located on the downstream side of the evaporator 31. The accumulator 38 may separate a liquid refrigerant from the refrigerant received from the evaporator 31, thereby preventing the liquid refrigerant from flowing into the compressor 32.

The HVAC system 11 may further include a branch conduit 36 branching off from the refrigerant circulation path 21. The branch conduit 36 may branch off from an upstream point of the cooling-side expansion valve 15 in the refrigerant circulation path 21 and be connected to the compressor 32. The battery chiller 37 may be fluidly connected to the branch conduit 36, and the battery chiller 37 may be configured to transfer heat between the branch conduit 36 and the battery coolant circulation path 22. In other words, the battery chiller 37 may be configured to transfer heat between the refrigerant circulating in the HVAC system 11 and the battery coolant circulating in the battery cooling system 12.

Specifically, the battery chiller 37 may include a first passage 37a fluidly connected to the branch conduit 36, and a second passage 37b fluidly connected to the battery coolant circulation path 22. The first passage 37a and the second passage 37b may be adjacent to each other or contact each other in the battery chiller 37. The first passage 37a may be fluidly separated from the second passage 37b. Accordingly, the battery chiller 37 may be configured to transfer heat between the battery coolant passing through the second passage 37b and the refrigerant passing through the first passage 37a. The refrigerant may absorb heat from the battery coolant so that it may be vaporized and superheated, and the battery coolant may release heat to the refrigerant so that it may be cooled.

The branch conduit 36 may be fluidly connected to the accumulator 38, and the refrigerant passing through the branch conduit 36 may be received in the accumulator 38.

A chiller-side expansion valve 17 may be disposed on the upstream side of the battery chiller 37 in the branch conduit 36. The chiller-side expansion valve 17 may adjust the flow of the refrigerant and/or the flow rate of the refrigerant into the battery chiller 37. The chiller-side expansion valve 17 may be configured to expand the refrigerant received from the exterior heat exchanger 35.

According to an embodiment, the chiller-side expansion valve 17 may be an EXV having a drive motor 17a. The drive motor 17a may have a shaft which is movable to open or close an orifice defined in a valve body of the chiller-side expansion valve 17. The position of the shaft may be varied depending on the rotation direction, rotation degree, and the like of the drive motor 17a. Accordingly, the opening degree of the chiller-side expansion valve 17 may be varied. In other words, as the controller 100 controls the operation of the drive motor 17a, the opening degree of the chiller-side expansion valve 17 may be varied. The chiller-side expansion valve 17 may be a full open type EXV. The chiller-side expansion valve 17 may have a structure which is the same as or similar to that of the heating-side expansion valve 16.

As the opening degree of the chiller-side expansion valve 17 is varied, the flow rate of the refrigerant into the battery chiller 37 may be varied. For example, when the opening degree of the chiller-side expansion valve 17 is greater than a reference opening degree, the flow rate of the refrigerant into the battery chiller 37 may be relatively increased above a reference flow rate. Additionally, when the opening degree of the chiller-side expansion valve 17 is less than the reference opening degree, the flow rate of the refrigerant into the battery chiller 37 may be similar to the reference flow rate or be relatively lowered below the reference flow rate. The reference opening degree refers to an opening degree of the chiller-side expansion valve 17 required for maintaining a target evaporator temperature, and the reference flow rate refers to a flow rate of the refrigerant into the battery chiller 37 when the chiller-side expansion valve 17 is opened to the reference opening degree. Accordingly, when the chiller-side expansion valve 17 is opened to the reference opening degree, the refrigerant may flow into the battery chiller 37 at the corresponding reference flow rate.

As the opening degree of the chiller-side expansion valve 17 is adjusted by the controller 100, the flow rate of the refrigerant into the battery chiller 37 may be varied, and accordingly, the flow rate of the refrigerant into the evaporator 31 may be varied. As the opening degree of the chiller-side expansion valve 17 is adjusted, the refrigerant may be distributed to the evaporator 31 and the battery chiller 37 at a predetermined ratio. Accordingly, the cooling of the HVAC system 11 and the cooling of the battery chiller 37 may be performed simultaneously or selectively.

The HVAC system 11 may further include a refrigerant bypass conduit 39 connecting a downstream point of the refrigerant passage 71 of the water-cooled heat exchanger 70 and the branch conduit 36. An inlet of the refrigerant bypass conduit 39 may be connected to the downstream point of the water-cooled heat exchanger 70, and an outlet of the refrigerant bypass conduit 39 may be connected to the branch conduit 36. Specifically, the inlet of the refrigerant bypass conduit 39 may be connected to a point between the water-cooled heat exchanger 70 and the exterior heat exchanger 35, and the outlet of the refrigerant bypass conduit 39 may be connected to a point between the battery chiller 37 and the compressor 32 in the branch conduit 36. A first three-way valve 61 may be disposed at a connection point between the inlet of the refrigerant bypass conduit 39 and the refrigerant circulation path 21. Accordingly, the first three-way valve 61 may be disposed between the exterior heat exchanger 35 and the water-cooled heat exchanger 70 in the refrigerant circulation path 21. When the first three-way valve 61 is switched to open the inlet of the refrigerant bypass conduit 39, the refrigerant passing through the refrigerant passage 71 of the water-cooled heat exchanger 70 may be directed to the compressor 32 through the refrigerant bypass conduit 39 and the accumulator 38. In other words, when the inlet of the refrigerant bypass conduit 39 is opened by the switching of the first three-way valve 61, the refrigerant may bypass the exterior heat exchanger 35. When the first three-way valve 61 is switched to close the inlet of the refrigerant bypass conduit 39, the refrigerant passing through the refrigerant passage 71 of the water-cooled heat exchanger 70 may not pass through the refrigerant bypass conduit 39, but may be directed to the exterior heat exchanger 35. In other words, when the inlet of the refrigerant bypass conduit 39 is closed by the switching of the first three-way valve 61, the refrigerant may pass through the exterior heat exchanger 35.

The controller 100 may be configured to control respective operations of the shut-off valve 15a of the cooling-side expansion valve 15, the heating-side expansion valve 16, the chiller-side expansion valve 17, the compressor 32, and the like. Thus, the overall operation of the HVAC system 11 may be controlled by the controller 100. According to an embodiment, the controller 100 may be a fully automatic temperature control (FATC) system.

When the HVAC system 11 operates in a cooling mode, the shut-off valve 15a of the cooling-side expansion valve 15 may be opened, and the refrigerant may sequentially pass through the compressor 32, the interior condenser 33, the heating-side expansion valve 16, the refrigerant passage 71 of the water-cooled heat exchanger 70, the exterior heat exchanger 35, the cooling-side expansion valve 15, and the evaporator 31.

The battery cooling system 12 may be configured to cool a battery 41 using the battery coolant circulating in the battery coolant circulation path 22. The battery coolant circulation path 22 may be fluidly connected to the battery 41, a heater 42, the battery chiller 37, a second battery pump 45, a battery radiator 43, a reservoir tank 48, and a first battery pump 44. In FIG. 1, the battery coolant may sequentially pass through the battery 41, the heater 42, the battery chiller 37, the second battery pump 45, the battery radiator 43, the reservoir tank 48, the second coolant passage 73 of the water-cooled heat exchanger 70, and the first battery pump 44 in the battery coolant circulation path 22.

The battery 41 may have a coolant passage provided inside or outside thereof, and the battery coolant may pass through the coolant passage. The battery coolant circulation path 22 may be fluidly connected to the coolant passage of the battery 41.

The heater 42 may be disposed between the battery chiller 37 and the battery 41, and the heater 42 may be configured to heat the battery coolant circulating in the battery coolant circulation path 22 to thereby warm up the coolant. According to an embodiment, the heater 42 may be a water-heated heater that heats the coolant by exchanging heat with a high-temperature fluid. According to another embodiment, the heater 42 may be an electric heater.

The battery radiator 43 may be adjacent to the front grille of the vehicle, and the battery radiator 43 may be cooled using the ambient air forcibly blown by the cooling fan 75. The battery radiator 43 may be adjacent to the exterior heat exchanger 35.

The first battery pump 44 may be configured to allow the battery coolant to circulate through at least a portion of the battery coolant circulation path 22. The second battery pump 45 may be configured to allow the battery coolant to circulate through at least a portion of the battery coolant circulation path 22.

The first battery pump 44 may be located at an upstream point of the battery 41 in the battery coolant circulation path 22. Accordingly, the first battery pump 44 may be configured to forcibly pump the battery coolant into the battery 41, thereby allowing the battery coolant to pass through the battery 41.

The second battery pump 45 may be located at an upstream point of the battery radiator 43 in the battery coolant circulation path 22. Accordingly, the second battery pump 45 may be configured to forcibly pump the battery coolant into an inlet of the battery radiator 43, thereby allowing the battery coolant to pass through the battery radiator 43.

The first battery pump 44 and the second battery pump 45 may operate individually and selectively depending on the thermal condition and charging condition of the battery 41, the operating condition of the HVAC system 11, and the like.

The reservoir tank 48 may be disposed between an outlet of the battery radiator 43 and an inlet of the first battery pump 44.

The battery cooling system 12 may further include a first battery bypass conduit 46 allowing the battery coolant to bypass the battery radiator 43. The first battery bypass conduit 46 may be configured to directly connect an upstream point of the battery radiator 43 and a downstream point of the battery radiator 43 in the battery coolant circulation path 22.

An inlet of the first battery bypass conduit 46 may be connected to a point between the battery chiller 37 and the inlet of the battery radiator 43 in the battery coolant circulation path 22. Specifically, the inlet of the first battery bypass conduit 46 may be connected to a point between the battery chiller 37 and an inlet of the second battery pump 45 in the battery coolant circulation path 22.

An outlet of the first battery bypass conduit 46 may be connected to a point between the battery chiller 37 and the outlet of the battery radiator 43 in the battery coolant circulation path 22. Specifically, the outlet of the first battery bypass conduit 46 may be connected to a point between the inlet of the first battery pump 44 and an outlet of the reservoir tank 48 in the battery coolant circulation path 22.

The battery coolant may be directed from the downstream side of the battery chiller 37 to the upstream side of the first battery pump 44 through the first battery bypass conduit 46 so that the battery coolant may be allowed to bypass the second battery pump 45, the battery radiator 43, the reservoir tank 48, and the water-cooled heat exchanger 70. Accordingly, the battery coolant passing through the first battery bypass conduit 46 may sequentially pass through the battery 41, the heater 42, and the battery chiller 37 by the first battery pump 44.

The battery cooling system 12 may further include a second battery bypass conduit 47 allowing the battery coolant to bypass the battery 41, the heater 42, and the battery chiller 37. The second battery bypass conduit 47 may be configured to directly connect a downstream point of the battery chiller 37 and an upstream point of the battery 41 in the battery coolant circulation path 22.

An inlet of the second battery bypass conduit 47 may be connected to a point between the outlet of the first battery bypass conduit 46 and the outlet of the battery radiator 43 in the battery coolant circulation path 22. Specifically, the inlet of the second battery bypass conduit 47 may be connected to a point between the outlet of the first battery bypass conduit 46 and the outlet of the reservoir tank 48 in the battery coolant circulation path 22.

An outlet of the second battery bypass conduit 47 may be connected to a point between the inlet of the first battery bypass conduit 46 and the inlet of the battery radiator 43 in the battery coolant circulation path 22. Specifically, the outlet of the second battery bypass conduit 47 may be connected to a point between the inlet of the first battery bypass conduit 46 and the inlet of the second battery pump 45 in the battery coolant circulation path 22. The battery coolant may be directed from the downstream side of the battery radiator 43 to the upstream side of the second battery pump 45 through the second battery bypass conduit 47 so that the battery coolant may be allowed to bypass the battery 41, the heater 42, and the battery chiller 37. Accordingly, the battery coolant passing through the second battery bypass conduit 47 may sequentially pass through the battery radiator 43, the reservoir tank 48, and the second coolant passage 73 of the water-cooled heat exchanger 70 by the second battery pump 45.

The first battery bypass conduit 46 and the second battery bypass conduit 47 may be parallel to each other.

The battery cooling system 12 may further include a second three-way valve 62 disposed at the inlet of the first battery bypass conduit 46. In other words, the second three-way valve 62 may be disposed at a junction between the inlet of the first battery bypass conduit 46 and the battery coolant circulation path 22. When the second three-way valve 62 is switched to open the inlet of the first battery bypass conduit 46, a portion of the battery coolant (the battery coolant discharged from the battery chiller 37) may pass through the first battery bypass conduit 46 so that it may be allowed to bypass the battery radiator 43, and a remaining portion of the battery coolant (the battery coolant discharged from the battery radiator 43) may pass through the second battery bypass conduit 47 so that it may be allowed to bypass the battery 41, the heater 42, and the battery chiller 37. In other words, when the inlet of the first battery bypass conduit 46 is opened by the switching of the second three-way valve 62, the battery coolant circulation path 22 may form coolant circulation loops independent of each other through the first battery bypass conduit 46 and the second battery bypass conduit 47. The battery coolant passing through the first battery bypass conduit 46 may bypass the second battery pump 45, the battery radiator 43, the reservoir tank 48, and the water-cooled heat exchanger 70. Sequentially, the battery coolant may pass through the battery 41, the heater 42, and the battery chiller 37 by the operation of the first battery pump 44. The battery coolant passing through the second battery bypass conduit 47 may bypass the first battery pump 44, the battery 41, the heater 42, and the battery chiller 37. Sequentially, the coolant may pass through the battery radiator 43, the reservoir tank 48, and the water-cooled heat exchanger 70 by the operation of the second battery pump 45.

When the second three-way valve 62 is switched to close the inlet of the first battery bypass conduit 46, the battery coolant may not pass through the first battery bypass conduit 46. In other words, when the inlet of the first battery bypass conduit 46 is closed by the switching of the second three-way valve 62, the battery coolant may circulate through the battery coolant circulation path 22.

The battery cooling system 12 may be controlled by a battery management system 110. The battery management system 110 may monitor the state of the battery 41, and perform the cooling of the battery 41 when the temperature of the battery 41 is increased to a threshold temperature or higher. The battery management system 110 may transmit an instruction for the cooling of the battery 41 to the controller 100. Accordingly, the controller 100 may allow the compressor 32 to operate and allow the chiller-side expansion valve 17 to open. When the operation of the HVAC system 11 is not required during the cooling operation of the battery 41, the controller 100 may allow the cooling-side expansion valve 15 to close. In addition, the battery management system 110 may control the operation of the first battery pump 44 and the switching operation of the second three-way valve 62 so that the battery coolant may be allowed to bypass the battery radiator 43 and pass through the battery 41 and the battery chiller 37 as necessary.

The PE cooling system 13 may be configured to cool the electric motor 51 and the PE component 52 of an electric PE system using the PE coolant circulating in the PE coolant circulation path 23. The PE coolant circulation path 23 may be fluidly connected to the electric motor 51, the PE component 52, a PE radiator 53, a PE pump 54, and a reservoir tank 56. In FIG. 1, the PE coolant may sequentially pass through the electric motor 51, the PE radiator 53, the reservoir tank 56, the first coolant passage 72 of the water-cooled heat exchanger 70, and the PE component 52 in the PE coolant circulation path 23.

The electric motor 51 may have a coolant passage provided inside or outside thereof, and the PE coolant may pass through the coolant passage. The PE coolant circulation path 23 may be fluidly connected to the coolant passage of the electric motor 51.

The PE component 52 may include at least one PE component related to the driving of the electric motor 51 such as an inverter, OBC, and LDC. The PE component 52 may have a coolant passage provided inside or outside thereof, and the PE coolant may pass through the coolant passage. The PE coolant circulation path 23 may be fluidly connected to the coolant passage of the PE component 52.

The PE radiator 53 may be adjacent to the front grille of the vehicle, and the PE radiator 53 may be cooled using the ambient air forcibly blown by the cooling fan 75. The exterior heat exchanger 35, the battery radiator 43, and the PE radiator 53 may be disposed adjacent to each other on the front of the vehicle, and the cooling fan 75 may be disposed behind the exterior heat exchanger 35, the battery radiator 43, and the PE radiator 53.

The PE pump 54 may be disposed on the upstream side of the electric motor 51 and the PE component 52, and the PE pump 54 may be configured to allow the coolant to circulate in the PE coolant circulation path 23.

The PE cooling system 13 may further include a PE bypass conduit 55 allowing the PE coolant to bypass the PE radiator 53. The PE bypass conduit 55 may be configured to directly connect an upstream point of the PE radiator 53 and a downstream point of the PE radiator 53 in the PE coolant circulation path 23 so that the PE coolant discharged from an outlet of the electric motor 51 may be directed to an inlet of the PE pump 54 through the PE bypass conduit 55. Accordingly, the PE coolant may be allowed to bypass the PE radiator 53.

An inlet of the PE bypass conduit 55 may be connected to a point between the electric motor 51 and the PE radiator 53 in the PE coolant circulation path 23. An outlet of the PE bypass conduit 55 may be connected to a point between the reservoir tank 56 and the PE component 52 in the PE coolant circulation path 23. Specifically, the outlet of the PE bypass conduit 55 may be connected to a point between the reservoir tank 56 and the inlet of the PE pump 54 in the PE coolant circulation path 23.

The PE cooling system 13 may further include a third three-way valve 63 disposed at the inlet of the PE bypass conduit 55. The PE coolant may bypass the PE radiator 53 through the PE bypass conduit 55 by the switching of the third three-way valve 63. The PE coolant may sequentially pass through the electric motor 51, the first coolant passage 72 of the water-cooled heat exchanger 70, and the PE component 52 by the PE pump 54.

The reservoir tank 56 may be disposed on the downstream side of the PE radiator 53. In particular, the reservoir tank 56 may be disposed between the PE radiator 53 and the first coolant passage 72 of the water-cooled heat exchanger 70 in the PE coolant circulation path 23.

The switching of the third three-way valve 63 and the operation of the PE pump 54 in the PE cooling system 13 may be controlled by the controller 100.

When the HVAC system 11 operates in a heating mode, the shut-off valve 15a of the cooling-side expansion valve 15 may be closed, the opening degree of the heating-side expansion valve 16 may be adjusted, and the first three-way valve 61 may be switched to open the inlet of the refrigerant bypass conduit 39. The refrigerant compressed by the compressor 32 may be condensed in the interior condenser 33, and the refrigerant condensed by the interior condenser 33 may be expanded in the heating-side expansion valve 16. The expanded refrigerant may be evaporated in the refrigerant passage 71 of the water-cooled heat exchanger 70, and the evaporated refrigerant may be directed to the compressor 32 through the refrigerant bypass conduit 39. Thus, the refrigerant may sequentially pass through the compressor 32, the interior condenser 33, the heating-side expansion valve 16, and the water-cooled heat exchanger 70.

According to an embodiment of the present disclosure, the controller 100 may control the inverter 32c of the compressor 32 in a manner that allows the motor section 32b of the compressor 32 to operate in any one of an efficiency mode and a lossy mode. The inverter 32c may be configured to allow the motor section 32b to operate in any one of the efficiency mode and the lossy mode. An amount of heat generated from the compressor 32 when the motor section 32b operates in the lossy mode may be higher than an amount of heat generated from the compressor 32 when the motor section 32b operates in the efficiency mode. In other words, when the motor section 32b operates in the lossy mode under control of the inverter 32c, additional heat may be generated from the compressor 32.

According to an embodiment of the present disclosure, the controller 100 may be configured to control the inverter 32c of the compressor 32 based on a minimum temperature “Tr” of the refrigerant and a freezing temperature “To” of refrigerant oil contained in the refrigerant in a state in which the HVAC system 11 operates in the heating mode.

According to an embodiment of the present disclosure, in a state in which the HVAC system 11 operates in the heating mode, when a temperature difference (Tr−To) between the minimum temperature Tr of the refrigerant and the freezing temperature To of the refrigerant oil contained in the refrigerant is lower than a threshold value a and a component temperature Te of the compressor 32 is lower than an acceptable temperature, the controller 100 may be configured to control the inverter 32c of the compressor 32 in a manner that allows the compressor 32 to operate in a heat generating mode. The heat generating mode refers to a mode in which additional heat is generated from the compressor 32 as the inverter 32c allows the motor section 32b to operate in the lossy mode under control of the controller 100. In other words, as the motor section 32b operates in the lossy mode, heat may additionally be generated from components of the compressor 32, such as a power device of the inverter 32c and a coil of the motor section 32b. Accordingly, the temperature of the refrigerant discharged from the compressor 32 may relatively increase so that the refrigerant oil contained in the refrigerant may be prevented from freezing. In particular, heat additionally generated from the compressor 32 may be transferred to the cabin through the refrigerant, thereby improving cabin heating performance.

According to an embodiment of the present disclosure, when it is determined that the temperature difference (i.e., Tr−To) between the minimum temperature “Tr” of the refrigerant and the freezing temperature “To” of the refrigerant oil contained in the refrigerant is lower than the threshold value “a”, the controller 100 may be configured to calculate a vehicle required heat amount “Hr” and a maximum heat capacity “Hm”. The vehicle required heat amount Hr refers to the sum of an amount of heat required for the heating of the cabin based on a heating temperature set by an occupant and an amount of heat required for the warming-up of the battery 41 received from the battery management system 110. The maximum heat capacity Hm refers to a maximum amount of heat transferred from the refrigerant circulating in the refrigerant circulation path 21 of the HVAC system 11 to the cabin when the HVAC system 11 operates in the heating mode.

According to an embodiment of the present disclosure, when the maximum heat capacity Hm is lower than the vehicle required heat amount Hr, the controller 100 may be configured to select the most appropriate ones of control modes and control parameters of the motor section 32b of the compressor 32 based on a difference (i.e., Hr-Hm) between the vehicle required heat amount Hr and the maximum heat capacity Hm. The controller 100 may also calculate an amount of heat generated from the compressor 32 based on the selected control mode and control parameter, and estimate a component temperature “Te” of the compressor 32 based on the calculated amount of heat.

According to an embodiment of the present disclosure, when the estimated component temperature Te is lower than a first acceptable temperature “T1”, the controller 100 may control the inverter 32c of the compressor 32 in a manner that allows the compressor 32 to operate in the heat generating mode. Accordingly, as the motor section 32b operates in the lossy mode under control of the inverter 32c based on the selected control mode and control parameter, additional heat may be generated from the components of the compressor 32.

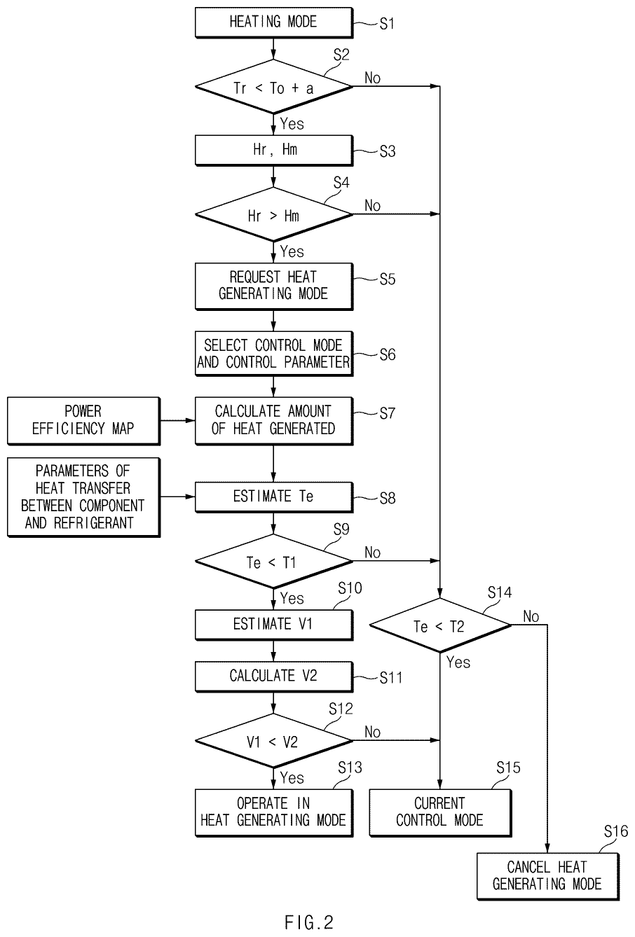

FIG. 2 illustrates a flowchart of a method of controlling a vehicle HVAC system according to an embodiment of the present disclosure.

The HVAC system 11 may operate in a heating mode (in an operation S1), and the controller 100 may monitor a temperature of the refrigerant sensed by a refrigerant temperature sensor, and check a freezing temperature of the refrigerant oil contained in the refrigerant.

The controller 100 may determine whether a temperature difference (i.e., Tr−To) between a minimum temperature “Tr” of the refrigerant and a freezing temperature “To” of the refrigerant oil contained in the refrigerant is lower than a threshold value “a” (in an operation S2). The threshold value refers to a reference temperature used to check whether the refrigerant oil is frozen at the minimum temperature of the refrigerant.

When it is determined, in the operation S2, that the temperature difference (Tr−To) between the minimum temperature “Tr” of the refrigerant and the freezing temperature “To” of the refrigerant oil contained in the refrigerant is lower than the threshold value “a”, the controller 100 may calculate a vehicle required heat amount “Hr” and a maximum heat capacity “Hm” (in an operation S3). The vehicle required heat amount Hr refers to the sum of an amount of heat required for the heating of the cabin based on a heating temperature set by an occupant and an amount of heat required for the warming-up of the battery 41 received from the battery management system 110. The maximum heat capacity Hm refers to a maximum amount of heat transferred to the cabin when the HVAC system 11 operates in the heating mode.

The controller 100 may determine whether the maximum heat capacity Hm is lower than the vehicle required heat amount Hr (in an operation S4).

When it is determined in S4 that the maximum heat capacity Hm is lower than the vehicle required heat amount Hr, the controller 100 may request that the compressor 32 operate in a heat generating mode (in an operation S5). The heat generating mode of the compressor 32 refers to an operating mode in which additional heat is generated from the components of the compressor 32 as the motor section 32b of the compressor 32 is controlled to operate in the lossy mode by the inverter 32c.

The controller 100 may select the most appropriate ones of control modes and control parameters of the motor section 32b of the compressor 32 based on a difference (i.e., Hr-Hm) between the vehicle required heat amount Hr and the maximum heat capacity Hm (in an operation S6).

In an operation S7, the controller 100 may calculate an amount of heat generated from the compressor 32 based on the control mode and control parameter selected in the operation S6. Specifically, the controller 100 may calculate the amount of heat generated from the compressor 32 by applying the selected control mode and control parameter to a power efficiency map. For example, the amount of heat generated from the compressor 32 may be the total sum of an amount of heat generated from the coil of the motor section 32b and an amount of heat generated from the power device of the inverter 32c.

The controller 100 may estimate a component temperature “Te” of the compressor 32 based on information on heat transfer between each component of the compressor 32 and the refrigerant (the temperature of the refrigerant, the flow rate of the refrigerant, revolutions per minute (RPM) of the compressor, and the like) and the calculated amount of heat (in an operation S8). For example, the controller 100 may estimate a temperature of the coil of the motor section 32b, and sense a temperature of the power device of the inverter 32c using a temperature sensor.

The controller 100 may determine whether the estimated component temperature “Te” is lower than a first acceptable temperature “T1” (in an operation S9). The first acceptable temperature T1 refers to a first reference temperature used to determine whether each component of the compressor 32 is likely to be damaged by the amount of heat generated.

When it is determined, in the operation S9, that the estimated component temperature Te is lower than the first acceptable temperature T1, the controller 100 may estimate a vibration and noise level V1 generated by the compressor 32 and the flow of the refrigerant based on the selected control mode and control parameter (in an operation S10). When the compressor 32 is controlled to operate in the lossy mode, the compressor 32 may physically vibrate. Since the vibration is transferred from the compressor 32 to the refrigerant flowing through the refrigerant circulation path 21, the vibration and noise may be generated by the compressor 32 and the flow of the refrigerant.

The controller 100 may calculate an acceptable vibration and noise level V2 based on various operating conditions (vehicle speed, air blower noise, vehicle audio, and the like) (in an operation S11).

The controller 100 may determine whether the vibration and noise level V1 generated by the compressor 32 and the flow of the refrigerant is less than the acceptable vibration and noise level V2 (in an operation S12).

When it is determined that the vibration and noise level V1 generated by the compressor 32 and the flow of the refrigerant is less than the acceptable vibration and noise level V2, the controller 100 may allow the compressor 32 to operate in the heat generating mode based on the selected control mode and control parameter (in an operation S13). In order to allow the motor section 32b to operate in the lossy mode under control of the inverter 32c based on the selected control mode and control parameter, the controller 100 may control the inverter 32c of the compressor 32 in a manner that allows the compressor 32 to operate in the heat generating mode. Thus, additional heat may be generated from the components of the compressor 32.

When it is determined in S9 that the estimated component temperature Te is higher than or equal to the first acceptable temperature T1, the controller 100 may determine whether the estimated component temperature Te is lower than a second acceptable temperature “T2” (in an operation S14). The second acceptable temperature T2 refers to a second reference temperature used to determine whether each component of the compressor 32 is likely to be damaged by the amount of heat generated, and the second acceptable temperature T2 may be higher than the first acceptable temperature T1.

When it is determined, in the operation S14, that the estimated component temperature Te is lower than the second acceptable temperature T2, the controller 100 may maintain the motor section 32b of the compressor 32 in the current control mode (in an operation S15).

When it is determined, in the operation S14, that the estimated component temperature Te is higher than or equal to the second acceptable temperature T2, the controller 100 may cancel the heat generating mode of the compressor 32 (in an operation S16).

When it is determined, in the operation S2, that the temperature difference (i.e., Tr−To) between the minimum temperature Tr of the refrigerant and the freezing temperature To of the refrigerant oil contained in the refrigerant is higher than or equal to the threshold value “a”, the controller 100 may determine whether the estimated component temperature Te is lower than the second acceptable temperature T2 (in the operation S14). Then, operations S15 and S16 may be performed based on the result of the operation S14.

When it is determined, in the operation S4, that the maximum heat capacity Hm is higher than or equal to the vehicle required heat amount Hr, the controller 100 may determine whether the estimated component temperature Te is lower than the second acceptable temperature T2 (in the operation S14). Then, operations S15 and S16 may be performed based on the result of the operation S14.

As set forth above, the vehicle HVAC system and the method of controlling the same according to embodiments of the present disclosure may be designed to control the inverter of the compressor in a manner that allows the motor section of the compressor to operate in the lossy mode based on the temperature of the refrigerant, the freezing temperature of the refrigerant oil, and the component temperature of the compressor so that the compressor may operate in the heat generating mode in which additional heat is generated from the compressor. Such an HVAC system and method may prevent the freezing of the refrigerant oil and relatively increase the RPM of the compressor, thereby improving the cabin heating performance.

Hereinabove, although the present disclosure has been described with reference to embodiments and the accompanying drawings, the present disclosure is not limited thereto. Instead, the present disclosure may be variously modified and altered by those having ordinary skill in the art to which the present disclosure pertains without departing from the spirit and scope of the present disclosure claimed in the following claims.

What is claimed is:

1. A vehicle heating, ventilation, and air conditioning (HVAC) system, comprising:
a compressor including a compression section, a motor section configured to drive the compression section, and an inverter configured to allow the motor section to operate in any one of an efficiency mode and a lossy mode; and
a controller configured to control the inverter of the compressor based on a minimum temperature of a refrigerant and a freezing temperature of refrigerant oil contained in the refrigerant.

2. The vehicle HVAC system according to claim 1, wherein:
the controller is configured to control the inverter of the compressor to operate in a heat generating mode when a temperature difference between the minimum temperature of the refrigerant and the freezing temperature of the refrigerant oil contained in the refrigerant is lower than a threshold value and a component temperature of the compressor is lower than an acceptable temperature; and
the heat generating mode is a mode in which additional heat is generated from the compressor as the inverter allows the motor section to operate in the lossy mode.

3. The vehicle HVAC system according to claim 1, wherein:
the controller is configured to calculate a vehicle desired heat amount and a maximum heat capacity when a temperature difference between the minimum temperature of the refrigerant and the freezing temperature of the refrigerant oil contained in the refrigerant is lower than a threshold value; and
the maximum heat capacity is a maximum amount of heat transferred from the refrigerant to a cabin when the HVAC system operates in a heating mode.

4. The vehicle HVAC system according to claim 3, wherein the controller is configured to:
when the maximum heat capacity is lower than the vehicle desired heat amount, select a control mode and a control parameter of the motor section of the compressor based on a difference between the vehicle desired heat amount and the maximum heat capacity;
calculate an amount of heat generated from the compressor based on the selected control mode and control parameter; and
estimate a component temperature of the compressor based on the calculated amount of heat.

5. The vehicle HVAC system according to claim 4, wherein the controller is configured to control the inverter of the compressor to operate in a heat generating mode when the estimated component temperature is lower than an acceptable temperature.

6. The vehicle HVAC system according to claim 4, wherein the controller is configured to estimate a vibration and noise level generated by the compressor and the refrigerant based on the selected control mode and control parameter when the estimated component temperature is lower than an acceptable temperature.

7. The vehicle HVAC system according to claim 6, wherein the controller is configured to control the inverter of the compressor to operate in a heat generating mode when the vibration and noise level generated by the compressor and the refrigerant is less than an acceptable vibration and noise level.

8. A method of controlling a vehicle heating, ventilation, and air conditioning (HVAC) system including a compressor having a compression section, a motor section configured to drive the compression section, and an inverter configured to allow the motor section to operate in any one of an efficiency mode and a lossy mode, the method comprising:
operating the HVAC system in a heating mode; and
controlling, by a controller, the inverter of the compressor based on a minimum temperature of a refrigerant and a freezing temperature of refrigerant oil contained in the refrigerant.

9. The method according to claim 8, wherein:
the controlling of the inverter includes controlling, by the controller, the inverter of the compressor to operate in a heat generating mode when a temperature difference between the minimum temperature of the refrigerant and the freezing temperature of the refrigerant oil contained in the refrigerant is lower than a threshold value and a component temperature of the compressor is lower than an acceptable temperature; and
the heat generating mode is a mode in which additional heat is generated from the compressor as the inverter allows the motor section to operate in the lossy mode.

10. The method according to claim 8, wherein:
the controlling of the inverter includes calculating, by the controller, a vehicle desired heat amount and a maximum heat capacity when a temperature difference between the minimum temperature of the refrigerant and the freezing temperature of the refrigerant oil contained in the refrigerant is lower than a threshold value; and
the maximum heat capacity is a maximum amount of heat transferred from the refrigerant to a cabin when the HVAC system operates in the heating mode.

11. The method according to claim 10, wherein the controlling of the inverter includes:
when the maximum heat capacity is lower than the vehicle desired heat amount, selecting, by the controller, a control mode and a control parameter of the motor section of the compressor based on a difference between the vehicle desired heat amount and the maximum heat capacity;
calculating, by the controller, an amount of heat generated from the compressor based on the selected control mode and control parameter; and
estimating, by the controller, a component temperature of the compressor based on the calculated amount of heat.

12. The method according to claim 11, wherein the controlling of the inverter includes controlling, by the controller, the inverter of the compressor to operate in a heat generating mode when the estimated component temperature is lower than an acceptable temperature.

13. The method according to claim 11, wherein the controlling of the inverter includes estimating, by the controller, a vibration and noise level generated by the compressor and the refrigerant based on the selected control mode and control parameter when the estimated component temperature is lower than an acceptable temperature.

14. The method according to claim 13, wherein the controlling of the inverter includes controlling, by the controller, the inverter of the compressor to operate in a heat generating mode when the vibration and noise level generated by the compressor and the refrigerant is less than an acceptable vibration and noise level.
